(19) United States
(12) Patent Application Publication
(10) Pub. No.: US 2017/0292670 A1
(43) Pub. Date: Oct. 12, 2017

(54) VEHICULAR LIGHTING DEVICE

(71) Applicant: STANLEY ELECTRIC CO., LTD., Tokyo (JP)

(72) Inventors: Philip RACKOW, Tokyo (JP); Tatsuma SAITO, Tokyo (JP); Yoshiaki NAKAZATO, Tokyo (JP); Naochika HORIO, Tokyo (JP)

(73) Assignee: STANLEY ELECTRIC CO., LTD., Tokyo (JP)

(21) Appl. No.: 15/630,548

(22) Filed: Jun. 22, 2017

Related U.S. Application Data
(63) Continuation of application No. PCT/JP2015/083914, filed on Dec. 2, 2015.

(30) Foreign Application Priority Data
Dec. 24, 2014 (JP) 2014-260276

(51) Int. Cl. F21S 8/10

(52) U.S. Cl. CPC F21S 48/1127; F21S 48/1145; F21S 48/1241; F21S 48/125

(57) ABSTRACT

A vehicular lighting device from which a fluorescent material is omitted that may cause deterioration of color rendering properties and occurrence of color separation is provided. The vehicular lighting device can have higher in color rendering properties than a conventional white light source obtained by combining a semiconductor light-emitting element such as an LD and the fluorescent material (wavelength converting member) and can suppress occurrence of color separation. A vehicular lighting device of the presently disclosed subject matter includes a supercontinuum light source that outputs supercontinuum light containing a visible wavelength region, and an optical system that controls the supercontinuum light output by the supercontinuum light source.

### CROSS-REFERENCE TO RELATED APPLICATIONS

The present application is a Continuation of PCT International Application No. PCT/JP2015/083914 filed on Dec. 2, 2015 claiming priority under 35 U.S.C §119(a) to Japanese Patent Application No. 2014-260276 filed on Dec. 24, 2014. Each of the above applications is hereby expressly incorporated by reference, in their entirety, into the present application.

### BACKGROUND OF THE INVENTION

### Field of the Invention

The presently disclosed subject matter relates to a vehicular lighting device, and in particular, relates to a vehicular lighting device using a supercontinuum light source.

### Description of the Related Art

Conventionally, in the field of vehicular lighting devices, there is proposed a vehicular lighting device using a semiconductor light-emitting element such as an LD (laser diode). For example, see Japanese Patent Application Laid-Open No. 2014-017096 (hereinafter referred to as PTL 1).

FIG. 22 is a schematic configuration diagram of a vehicular lighting device 200 disclosed in PTL 1.

As illustrated in FIG. 22, the vehicular lighting device 200 disclosed in PTL 1 includes semiconductor laser elements 202, condenser lenses 203, a fluorescent material 228, optical fibers 241 that propagate laser light that is radiated by the semiconductor laser elements 202 and is condensed by the condenser lenses 203 to the fluorescent material 228, and a reflecting mirror 229 that controls white light emitted by the fluorescent material 228 that has received the laser light propagated by the optical fibers 241.

### SUMMARY OF THE INVENTION

However, there are various problems caused by the fluorescent material 228 in the vehicular lighting device 200 disclosed in PTL 1, such as, for example, a problem that color rendering properties deteriorate since the spectrum of the light emitted by the fluorescent material contains two peaks and a deep valley formed between the relevant two peaks (that is, since the spectrum of the light emitted by the fluorescent material does not have continuity close to that of sunlight), and a problem of occurrence of color separation that the light emitted by the fluorescent material changes in color depending on its angle with respect to the light-emitting surface.

The presently disclosed subject matter is devised in view of such circumstances, and an object thereof is to provide a vehicular lighting device from which a fluorescent material is omitted that may cause deterioration of color rendering properties and occurrence of color separation (that is, a vehicular lighting device that is higher in color rendering properties than a conventional white light source obtained by combining a semiconductor light-emitting element such as an LD and the fluorescent material (wavelength converting member) and can suppress occurrence of color separation).

In order to achieve the aforementioned object, a vehicular lighting device according to a first aspect of the presently disclosed subject matter includes a supercontinuum light source that outputs supercontinuum light containing a visible wavelength region; and an optical system that controls the supercontinuum light output by the supercontinuum light source.

According to the first aspect, there can be provided the vehicular lighting device from which a fluorescent material is omitted that causes deterioration of color rendering properties and occurrence of color separation (that is, the vehicular lighting device that is higher in color rendering properties than a conventional white light source obtained by combining a semiconductor light-emitting element such as an LD and the fluorescent material (wavelength converting member) and can suppress occurrence of color separation).

The reason why the fluorescent material can be omitted is that the supercontinuum light output by the supercontinuum light source has already been white light.

The reason for the higher color rendering properties than those of the conventional white light source obtained by combining the semiconductor light-emitting element such as an LD and the fluorescent material (wavelength converting member) is that the spectrum of the supercontinuum light has continuity close to that of sunlight.

The reason why occurrence of color separation can be suppressed is that the supercontinuum light does not change (or does not almost change) in color depending on its angle since the fluorescent material is not used.

A vehicular lighting device according to a second aspect of the presently disclosed subject matter is configured such that, in the first aspect, the supercontinuum light source includes a pulse laser light source or a continuous wave (CW) laser light source, and a nonlinear optical medium that converts pulse laser light output by the pulse laser light source or continuous wave (CW) laser light output by the CW laser light source into the supercontinuum light to output the supercontinuum light.

According to the second aspect, the similar effects to those in the first aspect can be achieved.

A vehicular lighting device according to a third aspect of the presently disclosed subject matter is configured such that, in the second aspect, the nonlinear optical medium is an optical fiber for conversion configured so as to convert the pulse laser light output by the pulse laser light source or the CW laser light output by the CW laser light source into the supercontinuum light to output the supercontinuum light.

According to the third aspect, the similar effects to those in the first aspect can be achieved.

A vehicular lighting device according to a fourth aspect of the presently disclosed subject matter further includes, in addition to any of the first to third aspects, a transmitting optical fiber that propagates the supercontinuum light from the supercontinuum light source to the optical system, wherein the optical system controls the supercontinuum light exiting from an exiting end face of the transmitting optical fiber.

According to the fourth aspect, an optical fiber suitable for the vehicular lighting device can be used as the transmitting optical fiber. Moreover, even when a defect arises in the transmitting optical fiber, the relevant transmitting optical fiber can be easily replaced.

A vehicular lighting device according to a fifth aspect of the presently disclosed subject matter is configured such that, in the third aspect, the optical system controls the supercontinuum light exiting from an exiting end face of the optical fiber for conversion.

According to the fifth aspect, the transmitting optical fiber is unnecessary.

A vehicular lighting device according to a sixth aspect of the presently disclosed subject matter further includes, in addition to any of the first to fifth aspects, removing means that removes light other than a predefined visible wavelength region out of the supercontinuum light, wherein the optical system controls light obtained by removing the light other than the predefined visible wavelength region out of the supercontinuum light by the removing means.

According to the sixth aspect, ultraviolet light and/or infrared light out of the supercontinuum light can be suppressed from affecting constituent members of the vehicular lighting device (for example, an outer lens and a projection lens) and/or peripheral members thereof (for example, a housing and an extension), such as deterioration of these.

A vehicular lighting device according to a seventh aspect of the presently disclosed subject matter is configured such that, in the sixth aspect, the removing means is an optical filter or a dichroic mirror.

According to the seventh aspect, the similar effects to those in the sixth aspect can be achieved.

A vehicular lighting device according to an eighth aspect of the presently disclosed subject matter further includes, in addition to any of the first to seventh aspects, incoherence means that makes at least part of the supercontinuum light incoherent, wherein the optical system controls the supercontinuum light the at least part of which is made incoherent by the incoherence means.

According to the eighth aspect, since the supercontinuum light having a property of laser light can be made incoherent, eye safety can be realized.

A vehicular lighting device according to a ninth aspect of the presently disclosed subject matter is configured such that, in any of the first to eighth aspects, the optical system controls the supercontinuum light output by the supercontinuum light source such that a low-beam light distribution pattern is formed.

According to the ninth aspect, the low-beam light distribution pattern can be formed in the vehicular lighting device from which the fluorescent material is omitted that causes deterioration of color rendering properties and occurrence of color separation (that is, the vehicular lighting device that is higher in color rendering properties than a conventional white light source obtained by combining a semiconductor light-emitting element such as an LD and the fluorescent material (wavelength converting member) and can suppress occurrence of color separation).

A vehicular lighting device according to a tenth aspect of the presently disclosed subject matter is configured such that, in any of the first to eighth aspects, the optical system controls the supercontinuum light output by the supercontinuum light source such that a high-beam light distribution pattern is formed.

According to the tenth aspect, the high-beam light distribution pattern can be formed in the vehicular lighting device from which the fluorescent material is omitted that causes deterioration of color rendering properties and occurrence of color separation (that is, the vehicular lighting device that is higher in color rendering properties than a conventional white light source obtained by combining a semiconductor light-emitting element such as an LD and the fluorescent material (wavelength converting member) and can suppress occurrence of color separation).

According to the presently disclosed subject matter, there can be provided a vehicular lighting device from which a fluorescent material is omitted that causes deterioration of color rendering properties and occurrence of color separation (that is, a vehicular lighting device that is higher in color rendering properties than a conventional white light source obtained by combining a semiconductor light-emitting element such as an LD and the fluorescent material (wavelength converting member) and can suppress occurrence of color separation).

### BRIEF DESCRIPTION OF THE DRAWINGS

FIG. 1 is a longitudinal cross-sectional view of a vehicular lighting device 10 according to an embodiment of the presently disclosed subject matter;

FIG. 2 is an example of a high-beam light distribution pattern P_{Hi};

FIG. 3A is an elevation view of a white LD light source 24 configured by combining a blue LD element 24a and a yellow fluorescent material 24b (wavelength converting member);

FIG. 3B is a lateral view (a cross-sectional view) of the white LD light source 24;

FIG. 4 is a diagram illustrating a spectrum of light output by a white LD light source;

FIG. 5A is a diagram illustrating a directional property of a white LD light source;

FIG. 5B is a diagram illustrating a directional property of an SC light source (to be exact, an exiting end face 18b of a transmitting optical fiber 18);

FIG. 6A is an example of a spectrum of SC light output by a model name “WhiteLaser Micro”;

FIG. 6B is an example of a spectrum of SC light output by a model name “SC400”;

FIG. 6C is an example of a spectrum of SC light output by a model name “SCUV-3”;

FIG. 6D is an example of a spectrum of SC light output by a model name “SC450”;

FIG. 6E is an example of a spectrum of SC light output by a model name “SC480”;

FIG. 7A is an exemplary configuration of an SC light source 12 which outputs SC light containing a visible wavelength region;

FIG. 7B is an exemplary configuration of the SC light source 12 which outputs SC light containing a visible wavelength region;

FIG. 8 is an example of a spectrum of SC light containing a visible wavelength region;

FIG. 9 is an example of a spectrum of SC light containing a visible wavelength region;

FIG. 10 is an example of a spectrum of SC light containing a visible wavelength region;

FIG. 11 is an example of a spectrum of SC light containing a visible wavelength region;

FIG. 12 is an example of a spectrum of SC light containing a visible wavelength region;

FIG. 13 is an example of a spectrum of SC light containing a visible wavelength region;

FIG. 14A is an example of a taper fiber;

FIG. 14B is examples of spectra of SC light containing a visible wavelength region;

FIG. 15 is an example of a spectrum of SC light containing a visible wavelength region;

FIG. 16 is a cross-sectional view for explaining an internal structure of removing means 14;

FIG. 17A is an example of the transmitting optical fiber 18;

FIG. 17B is an example of the transmitting optical fiber 18;

FIG. 18A is an example of incoherence means;

FIG. 18B is an example of the incoherence means;

FIG. 19A is an example of the incoherence means;

FIG. 19B is an example of the incoherence means;

FIG. 20 is an exemplary configuration of a system controlling the vehicular lighting device 10;

FIG. 21 is a flowchart illustrating an operation example of the vehicular lighting device 10 (high-beam lighting device unit 16); and

FIG. 22 is a schematic configuration diagram of a vehicular lighting device 200 disclosed in PTL 1.

### DETAILED DESCRIPTION OF THE EMBODIMENTS

Hereafter, a vehicular lighting device which is an embodiment of the presently disclosed subject matter is described with reference to the drawings.

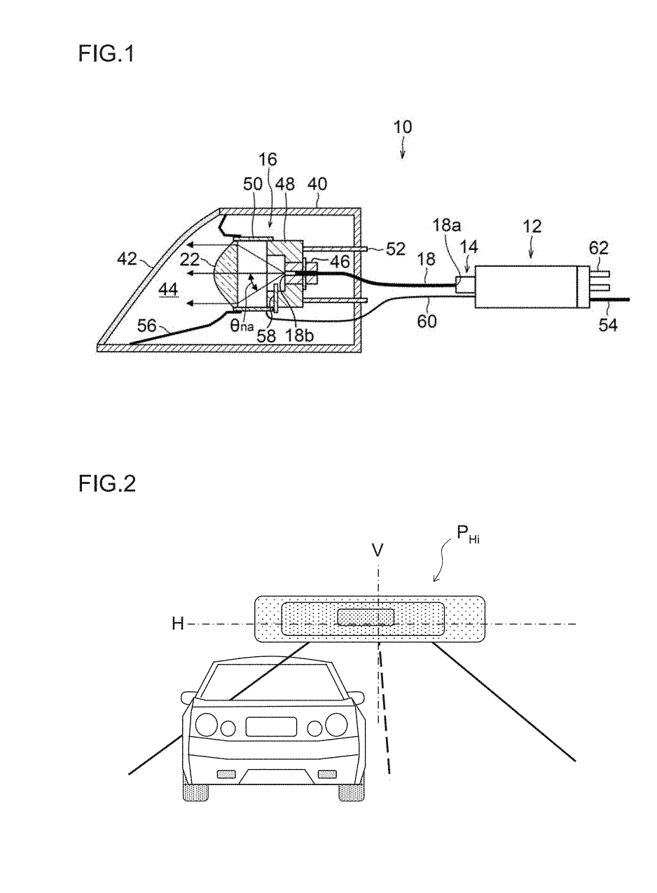

FIG. 1 is a longitudinal cross-sectional view of a vehicular lighting device 10 which is an embodiment of the presently disclosed subject matter. FIG. 2 is an example of a high-beam light distribution pattern P_{Hi} formed by the vehicular lighting device 10.

As illustrated in FIG. 1, the vehicular lighting device 10 is configured as a vehicular head lamp including: a supercontinuum light source 12 (hereafter referred to as SC light source) that outputs supercontinuum light (hereafter referred to as SC light) containing a visible wavelength region; removing means 14 that removes (cuts) light other than a predefined visible wavelength region (for example, 450 nm to 700 nm) out of the SC light output by the SC light source 12; an optical system 16 that controls the SC light output by the SC light source 12 (for example, a high-beam lighting device unit); and a transmitting optical fiber 18 that propagates the SC light output by the SC light source 12 to the high-beam lighting device unit 16.

The high-beam lighting device unit 16 is a lighting device unit that has an exiting end face 18b of the transmitting optical fiber 18 as a light source, includes a projection lens 22, and is disposed in a lighting chamber 44 configured between a housing 40 and an outer lens 42 attached thereto. Note that also the SC light source 12 may be disposed in the lighting chamber 44.

The transmitting optical fiber 18 is held on a sleeve 46 in the state where its exiting end part is inserted into an optical fiber inserting hole formed in the sleeve 46 attached to a lamp casing 48 and its exiting end face 18b is positioned close to the rear focal point of the projection lens 22. The entering end part of the transmitting optical fiber 18 is freely detachably mounted on the removing means 14.

The projection lens 22 is a convex lens, for example, in which the front side surface is a convex lens surface and the rear side surface is a flat surface, and is disposed in front of the exiting end face 18b of the transmitting optical fiber 18 in the state of being held by a lens holder 50. Furthermore, reference numeral 52 designates an optical axis adjusting mechanism. Reference numeral 54 designates a power supply/signal line. Reference numeral 56 designates an extension. Reference numeral 58 designates a light receiving sensor. Reference numeral 60 designates a light receiving sensor signal line. Reference numeral 62 designates a radiator plate.

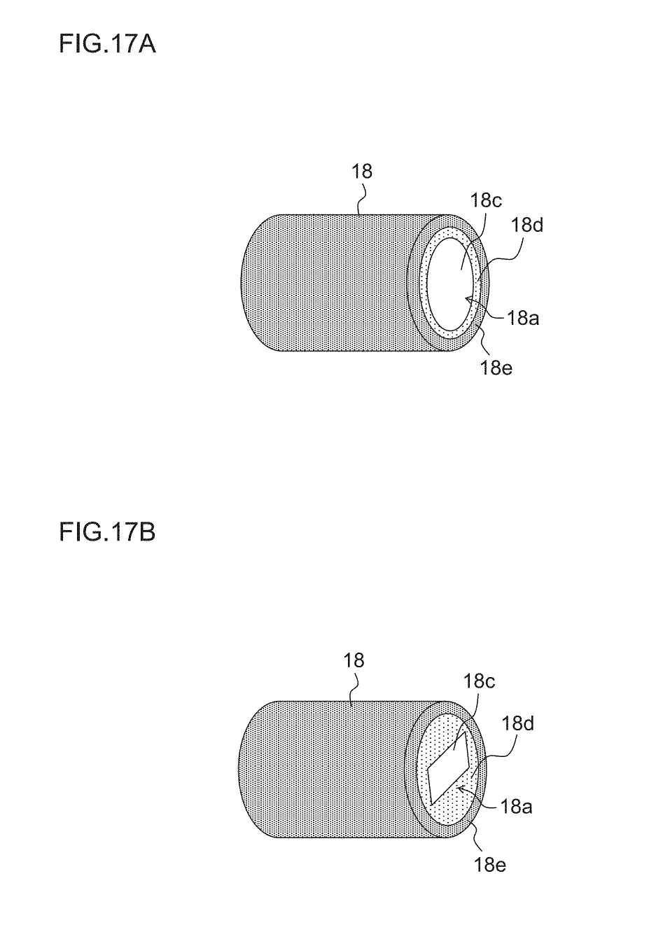

From the SC light that contains a visible wavelength region and is output by the SC light source 12, light other than the predefined visible wavelength region (for example, 450 nm to 700 nm) is removed by the removing means 14. After that, the SC light is condensed by the condenser lens 20 (see FIG. 16) and introduced from the entering end face 18a of the transmitting optical fiber 18 into the inside of the relevant transmitting optical fiber 18. Then, the SC light is propagated to the exiting end face 18b to exit from the relevant exiting end face 18b, and is transmitted through the projection lens 22 to be radiated forward, thus forming the high-beam light distribution pattern P_{Hi} illustrated in FIG. 2.

Supercontinuum is a phenomenon that when ultrashort light pulse or the like such, for example, as laser light (pulse laser light) output by a pulse laser light source or laser light (CW (Continuous Wave) laser light; also referred to as continuous light) output by a CW laser light source is caused to enter a nonlinear optical material, its spectrum continuously and steeply spreads due to nonlinear optical effects such as self-phase modulation, cross-phase modulation, four-wave mixing and Raman scattering. The light whose spectrum has spread due to this phenomenon is called SC light. Since the SC light is multiwavelength coherent light, it has very weak speckle noise (not sensed with the naked eye) and it can be used for an illumination light source without any speckle noise measure.

Advantages of using the SC light source 12 (to be exact, the exiting end face 18b of the transmitting optical fiber 18) as a light source of a vehicular lighting device such as the high-beam lighting device unit 16 are as follows.

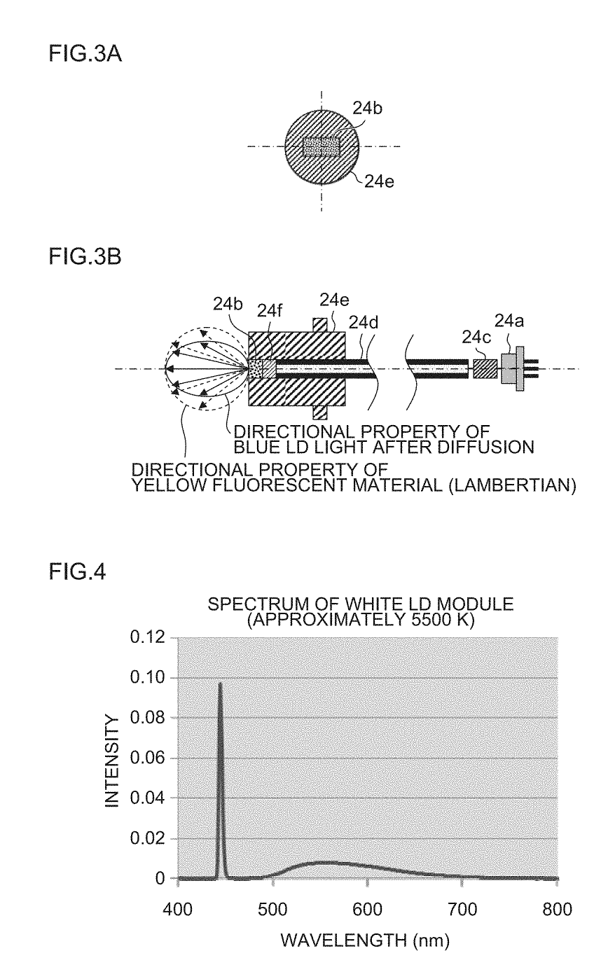

First, as illustrated in FIG. 3A and FIG. 3B, as compared with a white LD light source 24 configured by combining a blue LD element 24a and a yellow fluorescent material 24b (wavelength converting member), the yellow fluorescent material 24b (wavelength converting member) is not needed.

The reason is that while in the white LD light source 24 configured by combining the blue LD element 24a and the yellow fluorescent material 24b (wavelength converting member), the yellow fluorescent material 24b (wavelength converting member) having received blue laser light from the blue LD element 24a releases white light (pseudo-white light) obtained by mixing the blue laser light passing through it and emitted light (yellow light) due to the blue laser light, in the SC light source 12, the SC light output by the relevant SC light source 12 (to be exact, the SC light exiting from the exiting end face 18b of the transmitting optical fiber 18) has been already white light.

Furthermore, in FIG. 3B, reference numeral 24c designates a condenser lens. Reference numeral 24d designates an optical fiber. Reference numeral 24e designates a sleeve holding the yellow fluorescent material 24b, a diffusion member 24f, and the exiting end part of the optical fiber 24d. Reference numeral 24f designates the diffusion member that diffuses the laser light, from the blue LD element 24a, which exits from the exiting end part of the optical fiber 24d and enters the yellow fluorescent material 24b.

Second, as compared with the white LD light source 24 configured by combining the blue LD light source 24a and the yellow fluorescent material 24b (wavelength converting member), color rendering properties are improved.

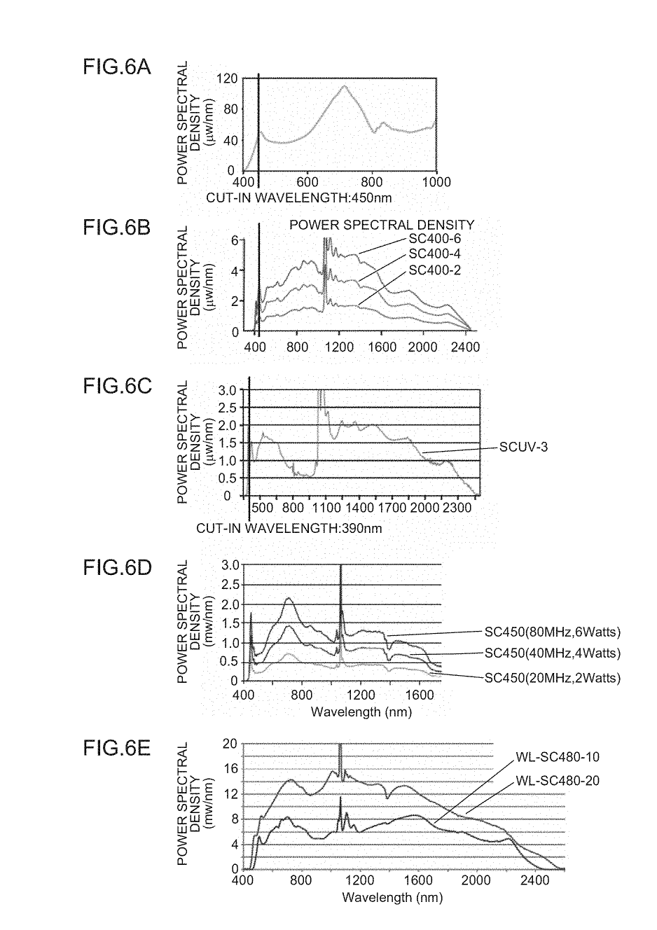

The reason is that while in the white LD light source 24 configured by combining the blue LD light source 24a and the yellow fluorescent material 24b (wavelength converting member), as illustrated in FIG. 4, its spectrum contains two peaks and a deep valley formed between the relevant two peaks, in the SC light source 12 (to be exact, the exiting end face 18b of the transmitting optical fiber 18), as illustrated in FIG. 6A to FIG. 6E and FIG. 8 to FIG. 15, its spectrum has continuity close to that of sunlight.

Third, as compared with the white LD light source 24 configured by combining the blue LD light source 24a and the yellow fluorescent material 24b (wavelength converting member), a directional property can be made narrow (as a result, more light can be input to a smaller projection lens 22. In other words, the projection lens 22 can be further downsized, and consequently, further downsizing of the vehicular lighting device 10 can be realized).

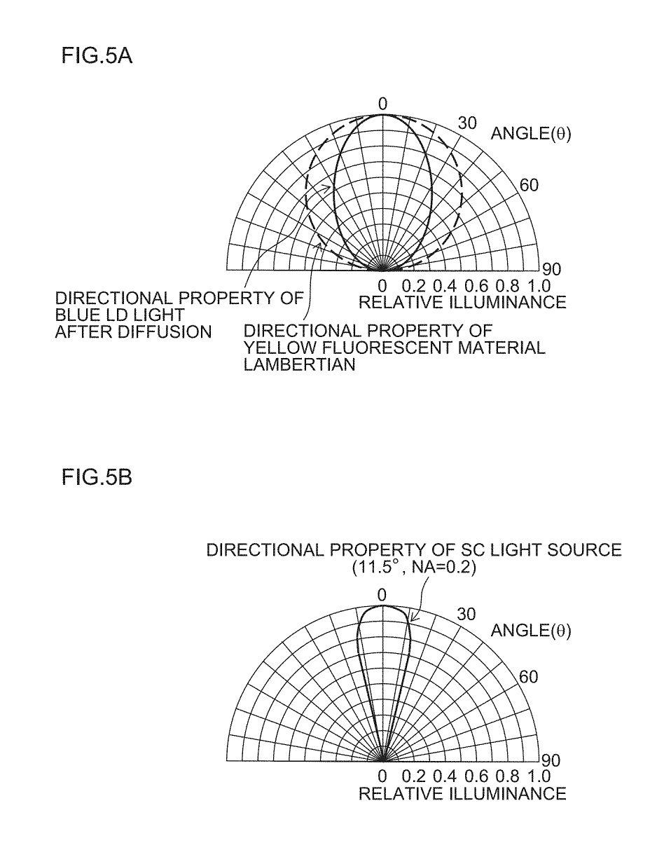

The reason is that while in the white LD light source 24 configured by combining the blue LD light source 24a and the yellow fluorescent material 24b (wavelength converting member), as illustrated in Figure SA, its directional property is Lambertian, in the SC light source 12 (to be exact, the exiting end face 18b of the transmitting optical fiber 18), as illustrated in FIG. 5B, its directional property can be made narrow. For example, by using an optical fiber with NA=0.2 as the transmitting optical fiber 18, the directional property with θₙₐ=11.5° can be set. By adjusting NA, the directional property can be made further narrower.

As the SC light source 12 which outputs the SC light containing the visible wavelength region, for example, WhiteLaser series supercontinuum white light sources made by Fianium Ltd. (their model names: “WhiteLaser Micro”, “SC400”, “SCUV-3”, “SC450”, “SC480” and the like) can be used.

Any of these includes a pulse laser light source (for example, with a pulse width: 6 ps and a repetition frequency: 20-100 MHz), and a nonlinear optical medium such as an optical fiber, and as illustrated in FIG. 6A to FIG. 6E, outputs SC light containing a visible wavelength region (see http://www.tokyoinst.co.jp/product file/file/FI01_cat01 ja.pdf, http://forc-photonics.ru/data/files/sc-450-450-pp.pdf, and http://www.fianium.com/pdf/WhiteLase_SC480_BrightLase_v1.pdf). FIG. 6A to FIG. 6E are examples of spectra of SC light output by model names “WhiteLaser Micro”, “SC400”, “SCUV-3”, “SC450” and “SC480”, respectively.

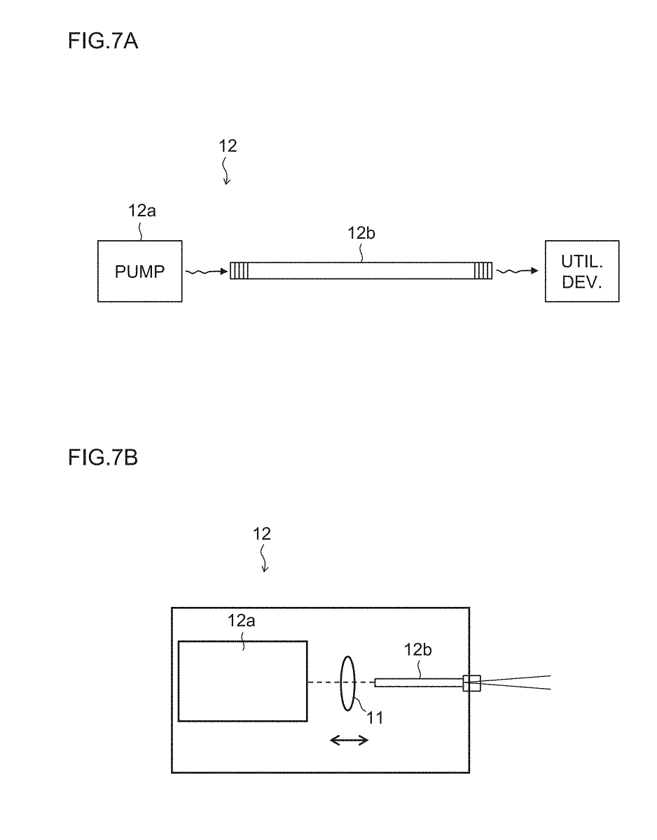

In general, as illustrated in FIG. 7A and FIG. 7B, the SC light source 12 which outputs the SC light containing the visible wavelength region includes a pulse laser light source 12a (or a CW laser light source), and a nonlinear optical medium 12b or the like that converts pulse laser light output by the pulse laser light source 12a (or CW laser light output by the CW laser light source) into the SC light to output it. FIG. 7A is an example of an SC light source that is disclosed in U.S. Pat. No. 6,097,870 and outputs SC light containing a visible wavelength region. FIG. 7B is an example of an SC light source that is disclosed in U.S. Pat. No. 6,611,643 and outputs SC light containing a visible wavelength region. Reference numeral 11 in FIG. 7B designates a focusing optical system.

As the pulse laser light source 12a, for example, mode-locked laser light sources (for example, titanium-sapphire laser light sources) can be used (see Oct. 1, 2000/Vol. 25, No. 19/OPTICS LETTERS 1415, http://www.nlo.hw.ac.uk/node/8, and Japanese Patent Application Laid-Open No. 2002-082286). Moreover, a fiber laser light source (for example, a ring-type laser light source using an erbium-doped fiber) can also be used (see Japanese Patent Application Laid-Open No. 2009-169041). Moreover, a Q-switch laser light source or the like can also be used (see U.S. Pub. No. 2014/0153888).

As the CW laser light source, for example, a fiber laser light source (for example, an yttrium-doped fiber) can be used (see http://cdn.intechopen.com/pdfs-wm/26780.pdf).

As the nonlinear optical medium 12b, an optical fiber for conversion configured so as to convert the pulse laser light output by the pulse laser light source 12a (or the CW laser light output by the CW laser light source) into the SC light to output it, such, for example, as a microstructured fiber (microstructured optical fiber) and a taper fiber (tapered fiber) can be used. The microstructured fiber 12b is known as a photonic crystal fiber (PCF), a holey fiber or a hole assist-type optical fiber (hole-assisted fiber).

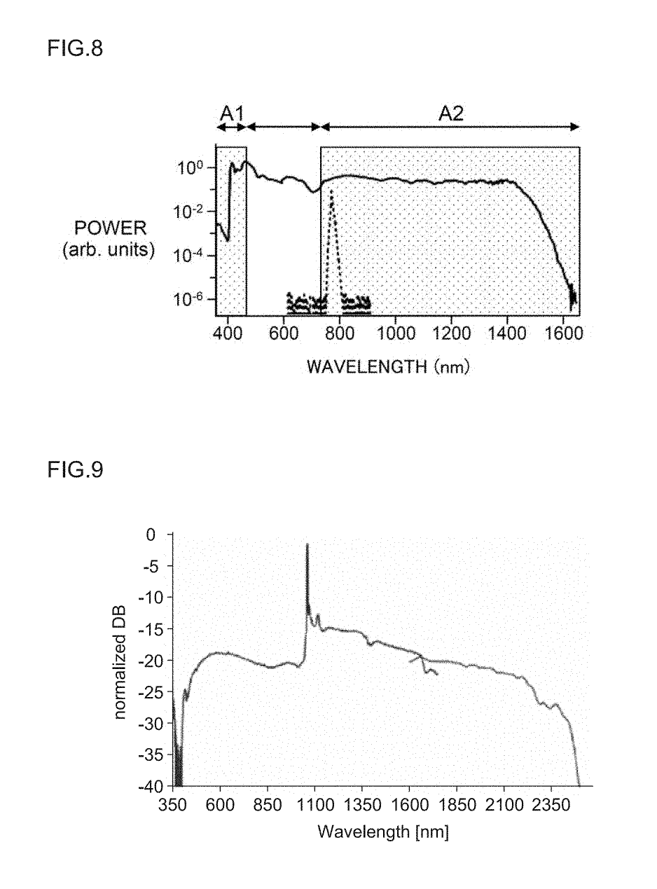

For example, as the microstructured fiber 12b, one disclosed in U.S. Pat. No. 6,097,870 (for example, with a core diameter: 0.5-7 μm) can be used. In this case, SC light containing a visible wavelength region illustrated in FIG. 8 can be output.

Moreover, for example, as the microstructured fiber 12b, one disclosed in U.S. Pub. No. 2014/0153888 (for example, with a core diameter: 1-5 μm) can be used. In this case, SC light containing a visible wavelength region illustrated in FIG. 9 can be output.

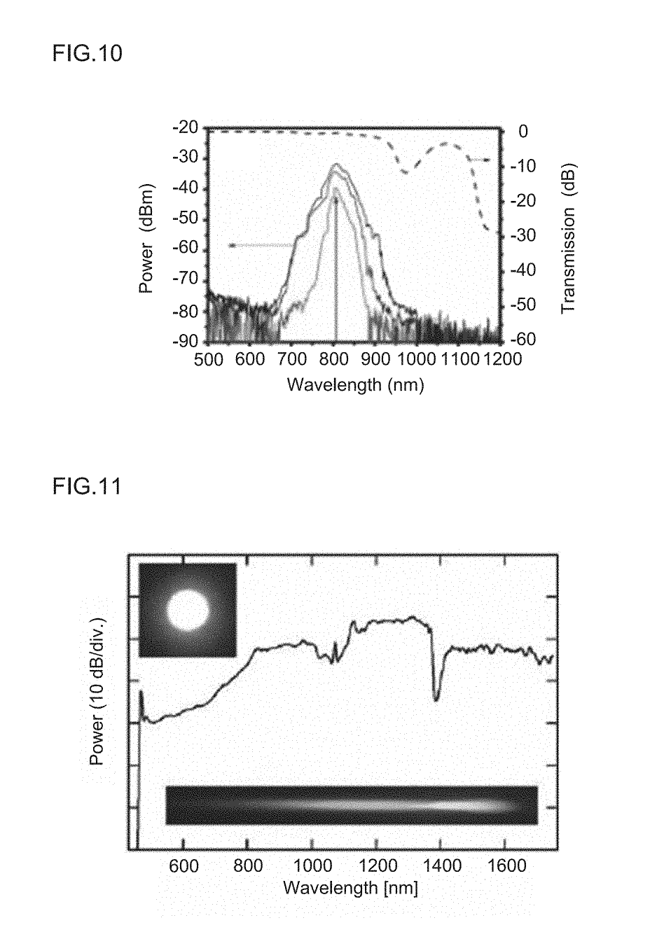

Moreover, for example, as the microstructured fiber 12b, one disclosed in 23 Jun. 2008/Vol. 16, No. 13/OPTICS EXPRESS 9671 can be used. In this case, SC light containing a visible wavelength region illustrated in FIG. 10 can be output.

Moreover, for example, as the microstructured fiber 12b, one disclosed in http://cdn.intechopen.com/pdfs-wm/26780.pdf can be used. In this case, SC light containing a visible wavelength region illustrated in FIG. 11 can be output.

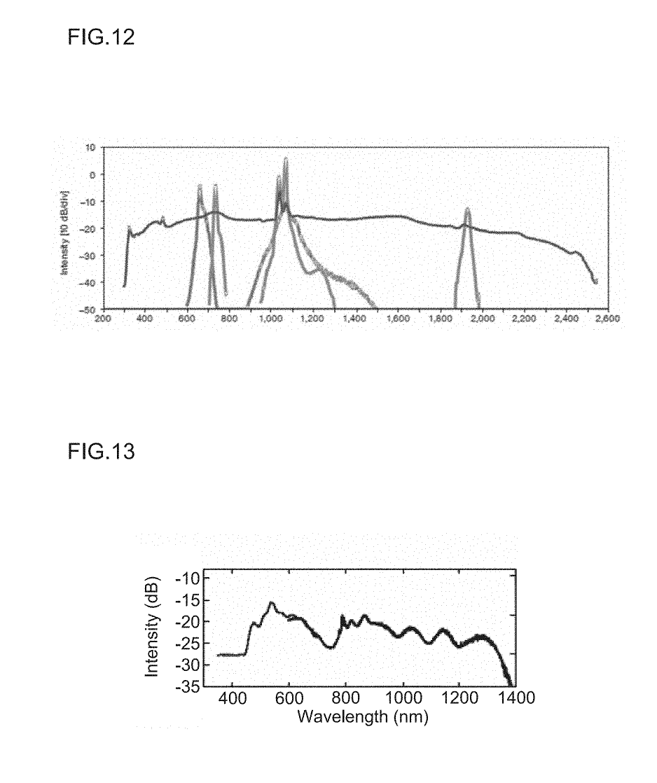

Moreover, for example, as the microstructured fiber 12b, one disclosed in http://www.osa-opn.org/home/articles/volume_23/issue_3/features/of-the-art_photonic_crystal_fiber/#.VIbBOMkorpI can be used. In this case, SC light containing a visible wavelength region illustrated in FIG. 12 can be output.

Moreover, for example, as the microstructured fiber 12b, one disclosed in Japanese Patent Application Laid-Open No. 2009-169041 can be used. In this case, SC light containing a visible wavelength region illustrated in FIG. 13 can be output.

Moreover, for example, as the microstructured fiber 12b, one disclosed in U.S. Pat. No. 6,611,643 can be used. In this case, SC light (not illustrated) containing a visible wavelength region can be output.

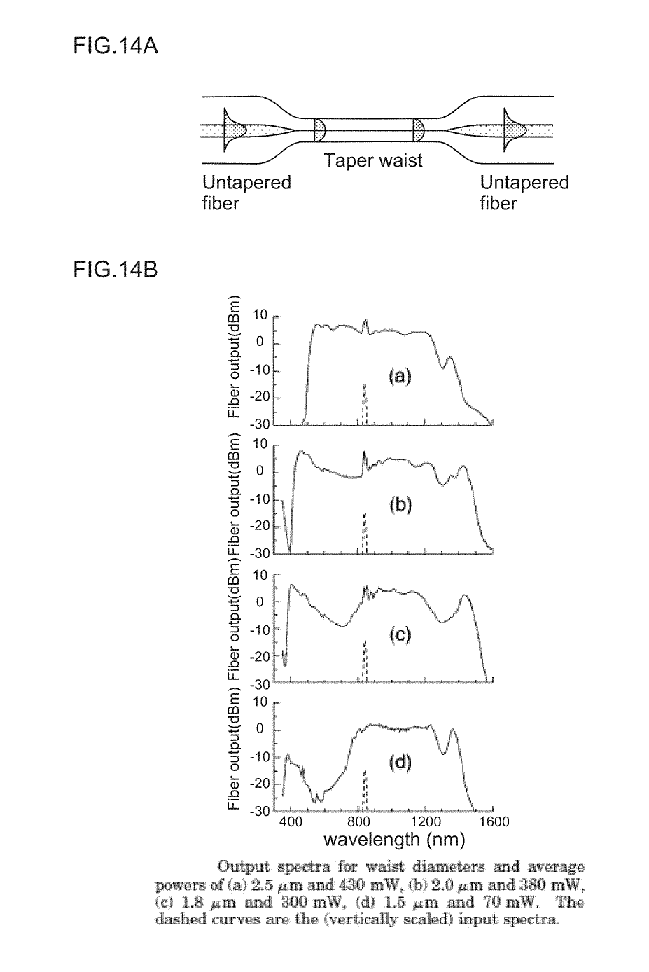

Moreover, for example, as the taper fiber (tapered fiber), one disclosed in Oct. 1, 2000/Vol. 25, No. 19/OPTICS LETTERS 1415 (for example, with a core diameter: 8.2 μm and a waist diameter: 1.5-2.0 μm; see FIG. 14A) can be used. In this case, SC light containing a visible wavelength region illustrated in FIG. 14B can be output.

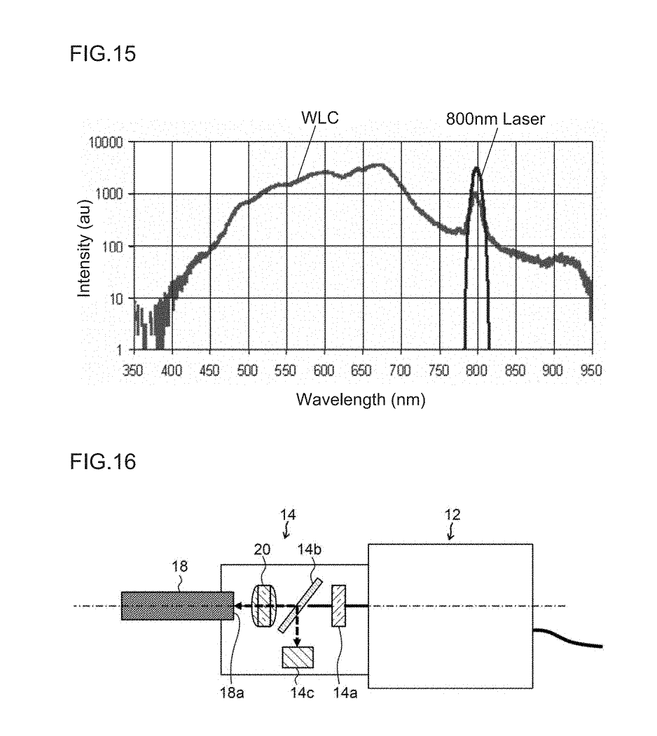

Moreover, for example, as the nonlinear optical medium, one disclosed in http://www.nlo.hw.ac.uk/node/8 can be used. In this case, SC light containing a visible wavelength region illustrated in FIG. 15 can be output.

FIG. 16 is a cross-sectional view for explaining an internal structure of the removing means 14.

As illustrated in FIG. 16, the removing means 14 is means that removes light other than the predefined visible wavelength region (for example, regions designated by reference characters A1 and A2 in FIG. 8) out of the SC light. With a spectral luminous efficiency (or a CIE standard spectral luminous efficiency of the International Commission on Illumination (CIE)) taken into consideration, the predefined visible wavelength region removed by the removing means 14 is preferably 450 nm to 700 nm. Of course not limited to this, the upper limit value and the lower limit value of the predefined visible wavelength region removed by the removing means 14 may be properly increased or decreased, for example, may be 460 nm to 630 nm, or may be other than this.

With the removing means 14, ultraviolet light and/or infrared light out of the SC light can be suppressed from affecting constituent members of the vehicular lighting device 10 (for example, the outer lens 42 and the projection lens 22) and/or peripheral members thereof (for example, the housing 40 and the extension 56), such as deterioration of these.

The removing means 14 is disposed between the SC light source 12 and the transmitting optical fiber 18 (entering end face 18a). Of course not limited to this, the removing means 14 may be disposed in the middle of the transmitting optical fiber 18, or may be disposed on the exiting end face 18b side of the transmitting optical fiber 18.

The removing means 14 includes, for example, first removing means 14a that removes, out of the SC light, light (for example, see the region A1 in FIG. 8) less than a wavelength close to the lower limit of the visible wavelength region (for example, 450 nm), and second removing means 14b that removes, out of the SC light, light (for example, see the region A2 in FIG. 8) exceeding a wavelength close to the upper limit of the visible wavelength region (for example, 700 nm).

The first removing means 14a is, for example, an optical filter that is disposed on the optical path of the SC light output by the SC light source 12, cuts the light (for example, see the region A1 in FIG. 8) less than a wavelength close to the lower limit of the visible wavelength region (for example, 450 nm), and allows the light not less than this to pass through. Of course not limited to this, the first removing means 14a may be a dichroic mirror that reflects the light less than a wavelength close to the lower limit of the visible wavelength region (for example, 450 nm) aside (for example, toward an ultraviolet light absorbing material disposed on the lateral side), and allows the light not less than this to pass through (none of these are illustrated).

The second removing means 14b is, for example, a dichroic mirror that is disposed on the optical path of the SC light having passed through the first removing means 14a, reflects the light (for example, see the region A2 in FIG. 8) exceeding a wavelength close to the upper limit of the visible wavelength region (for example, 750 nm) aside (for example, toward an infrared light absorbing material 14c disposed on the lateral side), and allows the light not more than this to pass through. Of course not limited to this, the second removing means 14b may be an optical filter (not illustrated) that cuts the light exceeding a wavelength close to the upper limit of the visible wavelength region (for example, 750 nm), and allows the light not more than this to pass through.

FIG. 17A and FIG. 17B are examples of the transmitting optical fiber 18.

As illustrated in FIG. 17A, the transmitting optical fiber 18 is an optical fiber including a core 18c including the entering end face 18a and the exiting end face 18b from which the SC light introduced from the entering end face 18a exits, and a cladding 18d surrounding the periphery of the core 18c, and the periphery of the cladding 18d is covered by a cover 18e. Here, the materials of the core 18c and the cladding 18d may be quartz glass, or may be synthetic resin, or may be another material.

The transmitting optical fiber 18 may be a single mode optical fiber, a multimode optical fiber, a step index-type optical fiber or a graded index-type optical fiber. In order to reduce coherence of the SC light, it is desirable to use the multimode optical fiber as the transmitting optical fiber 18.

The sectional shape of the transmitting optical fiber 18 may be circular (see FIG. 17A), rectangular (see FIG. 17B), or another shape other than these. As the light source of the vehicular lighting device, it is specially desirable to use an optical fiber whose sectional shape is rectangular and whose end face exiting intensity is in a top hat shape.

As the transmitting optical fiber 18, an optical fiber suitable for the vehicular lighting device 10 (for example, an optical fiber whose sectional shape is circular with a core diameter of 100 μm to 800 μm, or an optical fiber whose sectional shape is rectangular with a core of 100 μm×100 μm to 200 μm×400 μm) can be used. Moreover, since the transmitting optical fiber 18 is freely attachable and detachable with respect to the SC light source 12, even when a defect arises in the relevant transmitting optical fiber 18, the relevant transmitting optical fiber 18 can be easily replaced.

The SC light exiting from the exiting end face 18b of the transmitting optical fiber 18 can be reduced in coherence by the following incoherence means. Since with the incoherence means, the SC light having a property of laser light can be made incoherent, eye safety can be realized. Note that the incoherence means may be omitted.

For example, by using a multimode optical fiber as the transmitting optical fiber 18, spatial coherence can be reduced (some temporal coherence can also be reduced). The reason is that the intensity distribution is made even during propagating the SC light. Moreover, by making the transmitting optical fiber 18 (multimode optical fiber) long, by applying twist (kink) onto the transmitting optical fiber 18 (multimode optical fiber), or by increasing the number of loops of the transmitting optical fiber 18 (multimode optical fiber), spatial coherence can be further reduced. In particular, by using an optical fiber whose sectional shape is rectangular (see FIG. 17B) as the transmitting optical fiber 18, spatial coherence can be more effectively reduced than for an optical fiber whose sectional shape is circular.

Moreover, the SC light exiting from the exiting end face 18b of the transmitting optical fiber 18 can be reduced in coherence by applying high frequency vibration onto the transmitting optical fiber 18.

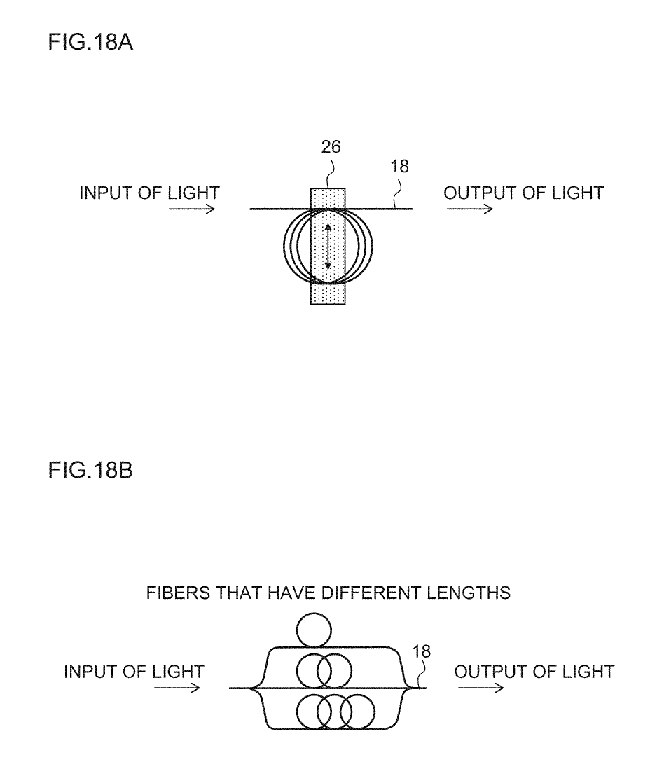

For example, as illustrated in FIG. 18A, by applying high frequency vibration at approximately 1.2 MHz in the radial direction or in the circumferential direction onto the transmitting optical fiber 18 which is looped by an oscillator 26, spatial coherence and temporal coherence can be reduced. The reason is that the refractive index of the transmitting optical fiber 18 fluctuates over time.

Moreover, as illustrated in FIG. 18B, the SC light exiting from the exiting end face 18b of the transmitting optical fiber 18 can be reduced in temporal coherence by disposing a plurality of branch optical fibers whose lengths are not the same as one another in parallel in the middle of the transmitting optical fiber 18. In this case, by using a multimode optical fiber as the transmitting optical fiber 18, spatial coherence can be simultaneously reduced.

Moreover, the SC light exiting from the exiting end face 18b of the transmitting optical fiber 18 can be reduced in coherence by an incoherence element 28.

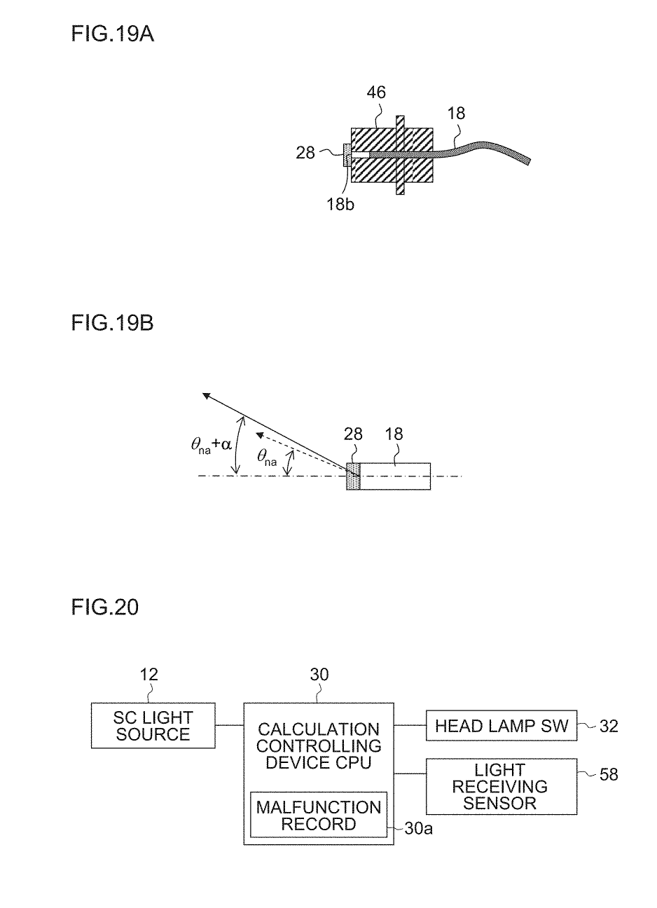

For example, as illustrated in FIG. 19A, by disposing the incoherence element 28 on the exiting end face 18b side of the transmitting optical fiber 18, coherence can be reduced.

As the incoherence element 28, for example, a translucent member in which a scattering agent is dispersed can be used. In this case, spatial coherence can be reduced. By using as the incoherence element, a diffractive scattering plate in which pores with pore diameters of approximately 1 μm to 5 μm are dispersed in translucent glass, or a diffractive scattering plate in which silicon carbide (SiC), alumina (Al₂O₃), aluminum nitride (AlN), titanium oxide (TiO₂) or the like, which are translucent high refractive materials, with particle diameters of approximately 1 μm to 5 μm is dispersed in translucent low refractive glass (n=1.4 or less), coherence can be reduced without impairing a narrow directional property. The particle diameter being 1 μm to 5 μm does not cause wide diffusion such as Rayleigh scattering but forward scattering, and hence, the narrow directional property can be held (see θₙₐ+α in FIG. 19B). Note that 0, in FIG. 19B designates a directional property in the case of not using the incoherence element 28.

Moreover, as the incoherence element 28, a diffractive optical element (DOE) such as a grating cell array or a hologram optical element (HOE) can also be used.

Moreover, as the incoherence element 28, a fluorescent light scattering plate in which fluorescent materials (blue, blue green, green, yellow, orange and red) excited by ultraviolet light are dispersed in a substrate body composed of a translucent resin, glass or crystal material can also be used. A scatterer may be added to the fluorescent materials with a different refractive index from that of the substrate body. In the case of using this fluorescent light scattering plate, the first removing means 14a can be omitted. Here, it is desired that the fluorescent materials are added in the amounts at which the visible light spectrum of the SC light is approximated to the visible light spectrum of sunlight.

Next, an exemplary configuration of a system controlling the vehicular lighting device 10 is described with reference to FIG. 20.

FIG. 20 is an exemplary configuration of a system controlling the vehicular lighting device 10.

As illustrated in FIG. 20, this system includes a calculation controlling device 30 (CPU: Central Processing Unit) that controls its overall operation. To the calculation controlling device 30, a head lamp switch 32, a light receiving sensor 58, the SC light source 12, a program storage (not illustrated) in which various programs executed by the calculation controlling device 30 are stored, a RAM (Random Access Memory; not illustrated) used for a working region and the like, and the like are connected via a bus. The light receiving sensor 58 is used for monitoring the output state of the SC light and detecting output abnormality thereof. Thereby, the SC light can be stopped in output adjustment or output abnormality of the SC light. Moreover, abnormality of the transmitting optical fiber 18 can also be detected.

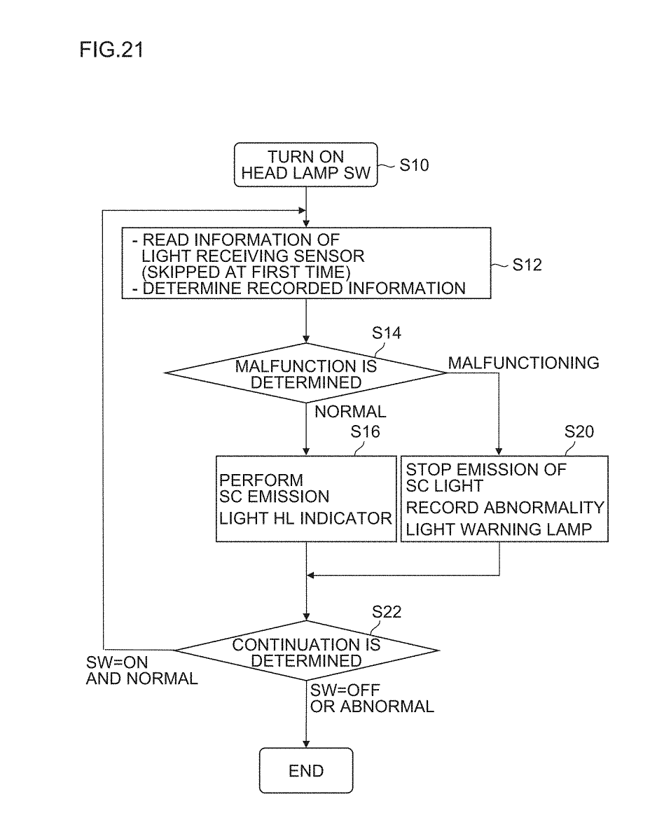

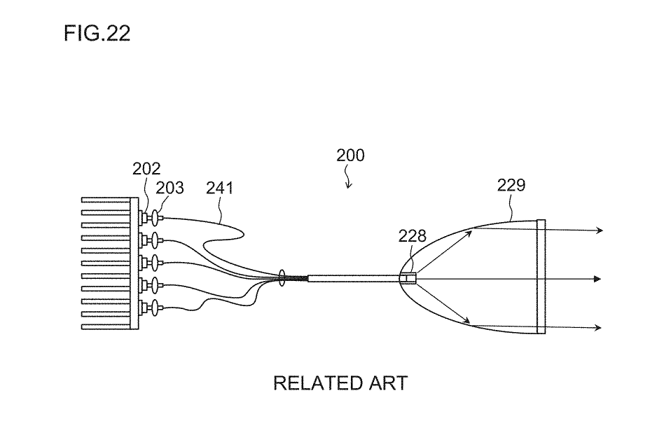

Next, exemplary operation of the vehicular lighting device 10 (high-beam lighting device unit 16) with the aforementioned configuration is described with reference to FIG. 21.

FIG. 21 is a flowchart illustrating exemplary operation of the vehicular lighting device 10 (high-beam lighting device unit 16).

The following processing can be realized by the calculation controlling device 30 executing a predetermined program read from the program storage to the RAM or the like.

First, upon turning on the head lamp switch 32 (step S10), read-in of information from the light receiving sensor 58 and determination of recorded information are performed (step S12). Next, malfunction determination of the SC light source 12 is performed (step S14). When normality is determined as a result (step S14: “Normal”), the SC light source 12 is controlled to output the SC light by the calculation controlling device 30 (step S16). In addition to this, that the SC light source 12 normally outputs the SC light is reported in the form of lighting of an HL (High Low) indicator or the like provided on an instrument panel or the like.

From the SC light containing the visible wavelength region output by the SC light source 12, the light other than a predefined visible wavelength region (for example, 450 nm to 700 nm) is removed by the removing means 14. After that, the SC light is condensed by the condenser lens 20 and introduced from the entering end face 18a of the transmitting optical fiber 18 into the inside of the relevant transmitting optical fiber 18. Then, the SC light is propagated to the exiting end face 18b to exit from the relevant exiting end face 18b, and at least part thereof is made incoherent by the incoherence means. After that, the SC light is transmitted through the projection lens 22 to be radiated forward, forming the high-beam light distribution pattern P_{Hi} illustrated in FIG. 2. Note that to make the SC light incoherent may be performed before it exits from the exiting end face 18b.

On the other hand, when malfunction is determined in step S14 (step S14: “Malfunctioning”), the SC light source 12 is controlled not to output the SC light by the calculation controlling device 30 (step S20). In addition to this, that the abnormality is recorded and the SC light source 12 is malfunctioning is reported in the form of lighting of a warning lamp or the like provided on the instrument panel or the like.

The above processing of steps S12 to S16 is repeatedly performed until the head lamp switch 32 is turned off or the malfunction is determined in step S14.

According to the present embodiment, there can be provided the vehicular lighting device 10 from which a fluorescent material (wavelength converting member) is omitted that causes deterioration of color rendering properties and occurrence of color separation (that is, a vehicular lighting device that is higher in color rendering properties than a conventional white light source obtained by combining a semiconductor light-emitting element such as an LD and the fluorescent material (wavelength converting member) and can suppress occurrence of color separation).

The reason why the fluorescent material can be omitted is that the SC light output by the SC light source 12 has already been white light.

The reason for the higher color rendering properties than those of the conventional white light source obtained by combining the semiconductor light-emitting element such as an LD and the fluorescent material (wavelength converting member) is that the spectrum of the SC light has continuity close to that of sunlight.

The reason why occurrence of color separation can be suppressed is that the SC light does not change (or does not almost change) in color depending on its angle since the fluorescent material is not used.

Next, modifications are described.

While in the aforementioned embodiment, an example in which the presently disclosed subject matter is applied to a vehicular head lamp using a so-called direct projection-type high-beam lighting device unit is described, the presently disclosed subject matter is not limited to this.

Namely, the presently disclosed subject matter can be widely applied to a vehicular head lamp using a direct projection-type low-beam lighting device unit, a vehicular head lamp using a projector-type high-beam lighting device unit (or low-beam lighting device unit), a vehicular head lamp using a reflector-type high-beam lighting device unit (or low-beam lighting device unit), a vehicular head lamp using a lens body containing a reflecting surface for forming a cutoff line (for example, see Japanese Patent Application Laid-Open No. 2003-317515), and various other vehicular lighting devices (containing external illumination devices such as a vehicular head lamp, interior illumination devices such as a room lamp, and signal-sign devices such as a clearance lamp).

Moreover, while in the aforementioned embodiment, an example of using the transmitting optical fiber 18 is described, the presently disclosed subject matter is not limited to this.

For example, the transmitting optical fiber 18 may be omitted and at least part (for example, the exiting end part side) of the optical fiber for conversion 12b (nonlinear optical medium) may be used as the transmitting optical fiber 18, which makes the transmitting optical fiber 18 unnecessary.

All the numerical values presented in the aforementioned embodiment and the modifications are exemplary, and proper numerical values different from these can be used.

The aforementioned embodiment is merely exemplary in all senses. The presently disclosed subject matter is not limitedly construed with these descriptions.

The presently disclosed subject matter can be implemented in various other forms without departing from the spirit or primary features thereof.

### REFERENCE SIGNS LIST

10 Vehicular lighting device
12 Supercontinuum light source
12a Pulse laser light source
12b Nonlinear optical medium (microstructured fiber; optical fiber for conversion)
14, 14a and 14b Removing means
14c Infrared light absorbing material
16 Optical system (high-beam lighting device unit)
18 Transmitting optical fiber
20 Condenser lens
22 Projection lens
26 Oscillator
28 Incoherence element

What is claimed is:

1. A vehicular lighting device comprising:
a supercontinuum light source that outputs supercontinuum light containing a visible wavelength region;
an optical system that controls the supercontinuum light output by the supercontinuum light source; and
a transmitting optical fiber that propagates the supercontinuum light from the supercontinuum light source to the optical system, the transmitting optical fiber being a multimode optical fiber.

2. The vehicular lighting device according to claim 1, wherein the supercontinuum light source includes:
a pulse laser light source or a continuous wave laser light source; and
a nonlinear optical medium that converts pulse laser light output by the pulse laser light source or continuous wave laser light output by the continuous wave laser light source into the supercontinuum light to output the supercontinuum light.

3. The vehicular lighting device according to claim 2, wherein the nonlinear optical medium is an optical fiber for conversion configured to convert the pulse laser light output by the pulse laser light source or the continuous wave laser light output by the continuous wave laser light source into the supercontinuum light to output the supercontinuum light.

4. The vehicular lighting device according to claim 1, further comprising
removing means that removes light other than a predefined visible wavelength region out of the supercontinuum light, wherein
the optical system controls light obtained by removing the light other than the predefined visible wavelength region out of the supercontinuum light by the removing means.

5. The vehicular lighting device according to claim 4, wherein the removing means is an optical filter or a dichroic mirror.

6. The vehicular lighting device according to claim 1, further comprising
incoherence means that makes at least part of the supercontinuum light incoherent, wherein
the optical system controls the supercontinuum light the at least part of which is made incoherent by the incoherence means.

7. The vehicular lighting device according to claim 1, wherein the optical system controls the supercontinuum light output by the supercontinuum light source such that a low-beam light distribution pattern is formed.

8. The vehicular lighting device according to claim 1, wherein the optical system controls the supercontinuum light output by the supercontinuum light source such that a high-beam light distribution pattern is formed.

9. The vehicular lighting device according to claim 1, wherein the optical system controls the supercontinuum light exiting from an exiting end face of the multimode optical fiber that is installed by twisting or looping the transmitting optical fiber.

10. The vehicular lighting device according to claim 1, wherein the optical system controls the supercontinuum light exiting from an exiting end face of the multimode optical fiber in which a core shape of the transmitting optical fiber is rectangular.

11. The vehicular lighting device according to claim 1, wherein the transmitting optical fiber is freely attachable and detachable to/from the optical system.

12. The vehicular lighting device according to claim 6, wherein the incoherence means is a diffractive optical element or a hologram optical element.
